(19) United States
(12) Patent Application Publication
(10) Pub. No.: US 2002/0130872 A1
(43) Pub. Date: Sep. 19, 2002

(54) Methods and systems for conflict resolution, summation, and conversion of function curves

(76) Inventors: Elena Novikova, Fairfax, VA (US); Stephen Milligan, Carrboro, NC (US); Richard Franklin Albury, Raleigh, NC (US)

Correspondence Address: KILPATRICK STOCKTON LLP, 3737 GLENWOOD AVENUE, SUITE 400, RALEIGH, NC, 27612, US

(21) Appl. No.: 09/808,782

(22) Filed: Mar. 15, 2001

(51) Int. Cl. G06T 13/00

(52) U.S. Cl. 345/473

(57) ABSTRACT

A method and system of resolving conflicts in sets of animation function curves, summing sets of function curves, and converting function curves from one mathematical representation to another. The method includes collecting actions from a source and resolving conflicts between actions from that source by the introduction, removal, or modification of successor actions in the action list. A list of existing actions is compiled and conflicts are resolved between self-consistent actions from a new source and the list of all prior existing actions. The method also determines the optimal result curve for a set of function curves. The method also includes converting a function curve from one mathematical representation to another when both representations cause the function curves to pass through keys.

### BACKGROUND OF THE INVENTION

1. Field of the Invention

This invention generally relates to computer animation, specifically to methods for resolving conflicts in, summing, and converting mathematical representations of function curves in an animation.

2. Description of the Related Art

As would be generally known and understood by those of ordinary skill in the art, function curves are an efficient method of representing and manipulating animation data. A function curve is a mathematical representation of the amplitude of any animatable quantity (such as the degree to which an eyebrow is raised or the angle at which a head is turned) with respect to time. As those of ordinary skill in the art of programming and mathematics recognize, a function curve can be interpolated between a set of control points. A control point, which is herein referred to synonymously as a key, is a point corresponding a time, value (or amplitude of an animatable quantity), first derivative in (slope of the curve approaching the time of the key), and first derivative out (slope of the curve leaving the key. A function curve is a list of keys and a mathematical representation which defines the interpolation of the curve between keys.

By altering the time, value (amplitude), and derivative of the keys, the shape of the function curves can be manipulated. In a function curve, any animatable quantity can be represented as the value component of a key as a function of time. For example, the motion of a walking person's foot can be described by six function curves, three for x, y, and z translation, and three for x, y, and z rotation, each a function of time. Other animatable quantities include size, transparency, or any variable that may be animated. Thus, the amplitude of the curve need not refer to motion: for example, the average luminosity of the light coming through a window in a 24-hour cycle can be represented as a single function curve.

In the animation of an object, there may be a large number of function curves, and the shape of each function curve may be very complex. There will also in many cases be a large number of function curves contributing to the behavior of a single quantity. For example, the average luminosity of the light coming through a window might have one function curve relating the brightness to the time of day and another relating it to time of year, another for the contribution of moonlight, yet another accounting for eclipses, etc.

An individual action may also involve multiple variable quantities, and thus consist of multiple function curves. As used herein, an action is a single time-constrained series of variations to an animatable quantity, along with the time of the action and any characteristics of the action necessary to unambiguously represent the action as a time slice of a function curve (e.g., for a blink, the duration of the blink). A single blink may involve a left eyelid and right eyelid track, while an “embarrassed gesture” action may consist of a host of curves, which cause the mouth to smile, the head to turn away, the eyes to look down, etc. This often causes more than one curve for a single animatable parameter. To continue with the above example, there may be one function curve controlling a set of eyelid movements which result from blinking, but there may be another function curve which controls the movements of the eyelids when one looks downward—(the eyelids lower to follow the upper edge of the pupil). The conversion of actions to keys is typically accomplished with a lookup table which lists all the keys for all the function curves of a particular action. The result is a set of function curves, many of which contribute to the value of the same animatable quantities.

Often the shape of a function curve depends on actions which are a result of some quantity generated by animation software. One disadvantage to actions generated by animation software, however, is that the actions sometimes contain conflicts in motion. Conflicts can arise when the function curve describes a quantity on which its future value depends. For example, a list of gestures generated by animation software to be performed by an animated figure. One action might be for the character to scratch its nose, and another action might be that the hand is holding a cup of coffee. These two actions are an example of a conflict because the character cannot scratch its nose while holding a cup of coffee in the same hand. This is referred to herein as conflict between different function curves contributing to the same quantity, for example the movement of a hand.

Another disadvantage to current animation techniques arises when a function curve or set of function curves for a certain animatable quantity must be evaluated for self-consistency. For example, an animated character may blink at random intervals. The function curve which controls when the character blinks uses itself as an input to determine when the next blink should take place, thus avoiding a situation where two blinks overlap in time or there is a long interval between blinks. Tests for self-consistency are of increased importance when the action-generating algorithm is complex. This is referred to herein as the problem of conflicts relating to self-consistency of a single function curve.

Both types of conflict contribute to the calculation of a quantity that is used to calculated successive values of itself. Current animation techniques do not provide for a consistent, integrated resolution of self-consistency of function curves and of conflicts between curves.

Another disadvantage with current animation techniques is that multiple function curves may result from animation generation. It is desirable to have an optimized, function curve controlling each animatable quantity for a variety of reasons. First, it is more efficient to read a single value from one curve at an instant in the animation than to read values from multiple curves and sum them. This is important in running real-time animations, or when transmitting the data for an animation across a network. Second, a single function curve is more easily edited than multiple curves, whether automatically or by human hand, because the affect of the manipulation of a key is more localized and obvious. Third, certain phenomena which depend on the result curve, such as maxima and minima, rates of change, inflection points, and so on, are detectable in a result curve, but invisible in the constituent curves. Consequently, there is a need in the art for a means of summing function curves which contribute to the value of a single animatable quantity.

As would be understood by one of ordinary skill in the art, function curves may use different mathematical representations. Examples of common mathematical representation are polynomial splines, such as Bezier and Hermite splines. Various animation tools, rendering engines, and animation players require the use of different mathematical representations. These different representations also provide different methods and parameters for controlling the shapes of curves. The mathematical representations themselves may be unknown for a particular application, with only data information and access methods provided. Consequently, there is a need in the art for a means of converting a function curve from one mathematical representation to another which can use data information and access methods.

### BRIEF SUMMARY OF THE INVENTION

One aspect involves a method of conflict resolution in an animation where there are multiple sources for an action, and where one source depends on another source for input. A computer program resolves self-consistency conflicts for each source of the action, and then resolves conflicts between two or more lists of actions.

The computer program resolves self-consistency conflicts by compiling a list of actions from an action source. The action source may be a list of actions or it may be an animation program that generates actions. The program tests for a conflict condition between each action on the list and the successor actions on the list. By successor action is meant any action subsequent in time to the action being tested for a conflict condition. The program applies a resolution method to any conflicts detected.

The resolution method involves at least one of the following steps: introducing at least one successor action to the source action list, removing at least one successor action to the source action list, or modifying at least one successor action in the source action list.

The program resolves conflicts between two or more lists of actions by adding all actions from the lists of actions to a cumulative action summary list. The program then tests for a conflict condition between each action in the action summary list and the successor actions. If a conflict is detected, the program applies a resolution method to the action list.

In another aspect, a computer program creates a resulting curve from a set of function curves. The program compiles a time-ordered list of keys from the function curves and determines the time, value, derivatives in, and derivatives out for each key.

If multiple keys in the compiled list of keys have the same time associated therewith, the program deletes all but one of the keys having the same time. The program sets the value of each key to the sum of the function curves at the time of the key. The program sets the derivative in of the key to the sum of the derivatives in of the function curve at the time of the key and sets the derivative out of the key to the sum of the derivatives out of the function curve.

In another aspect, the method involves converting the mathematical representation of a function curve. The computer program reads keys from a first curve that is defined in terms of a first mathematical representation which has times, values, and derivatives associated therewith. The program places the keys in a second curve defined in terms of a second mathematical representation of a function curve that corresponds to the extrema of the first curve. The times, values and derivatives in and out associated with the keys in the second curve are equal to the corresponding values in the first curve.

Preferably, the program determines points of maximum discrepancy between the first and second curves. The program then places new keys iteratively in the second curve at the points of maximum discrepancy between the first and second curves. The program terminates the iterative placement of new keys if termination criteria is met. Preferably, the termination criteria is met if the measure of the difference between the first and second curves is less than a threshold value. More preferably the threshold value is set to 10% of the range of values in the source curve. The termination criteria may also be met if a threshold number of placing new key iterations has occurred, where in a preferred embodiment the number of iterations is set to the length in time of the source curve divided by 33 ms. The termination criteria may also be met if a threshold amount of run time has elapsed, where in a preferred embodiment this run time threshold is set to 1 ms.

In another aspect, a system detects and resolves conflicts which arise between actions contributing to animation of a quantity. A computer program is stored on a computer system for detecting and resolving conflicts which arise between actions contributing to animation of a quantity. The program is configured to resolve self-consistency conflicts in each source of the action. The program is also configured to resolve conflicts between two or more lists of actions.

The program is configured to create a result curve from a set of function curves. The program compiles a time-ordered list of keys from the function curves and determines a value and derivative in and derivative out for each of the keys.

The program is configured to convert function curves from a first mathematical representation to a second mathematical representation. The program is configured to read keys from a first curve that is defined by a first mathematical representation, and place keys in a second curve represented by a second mathematical representation corresponding to the extrema of the first curve.

### BRIEF DESCRIPTION OF THE SEVERAL VIEWS OF THE DRAWINGS

These and other features, aspects, and advantages of the present invention are better understood when the following Detailed Description of the Invention is read with reference to the accompanying drawings, wherein:

FIGS. 1 and 2 are block diagrams illustrating the operating environment for the present invention;

FIG. 3 is a flowchart describing the Conflict Resolution, Summation, and Conversion Implementation.

FIGS. 4, 5, and 6 are flowcharts detailing the Conflict Resolution Implementation;

FIGS. 7 and 8 are flowcharts detailing the Function Curve Summation Implementation;

FIGS. 9 and 10 are flowcharts detailing the Mathematical Representation Conversion Implementation;

### DETAILED DESCRIPTION OF THE INVENTION

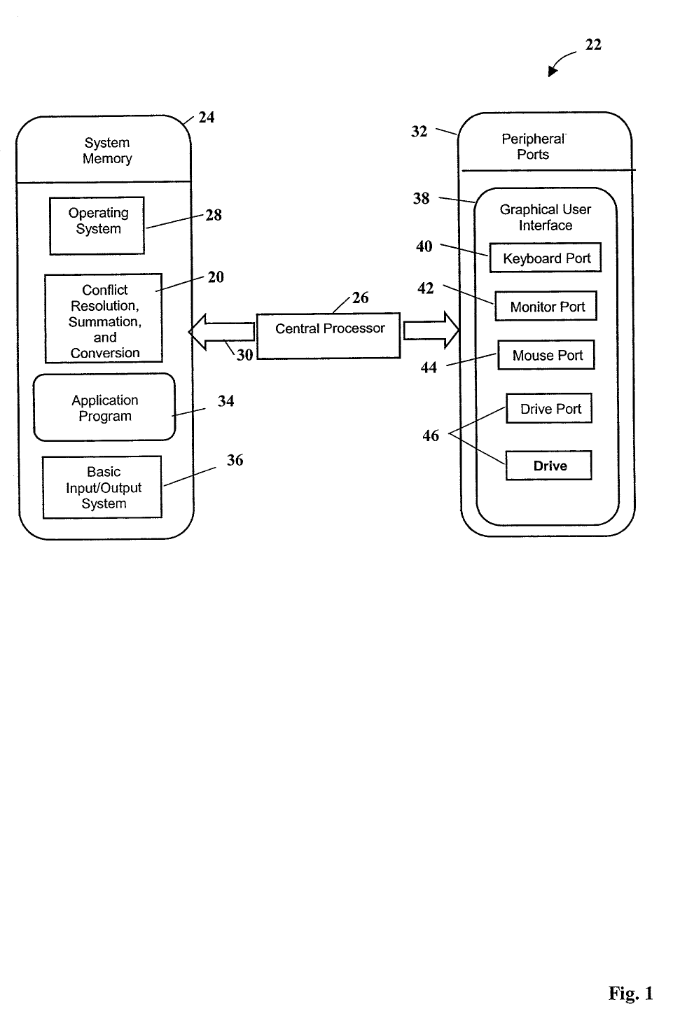

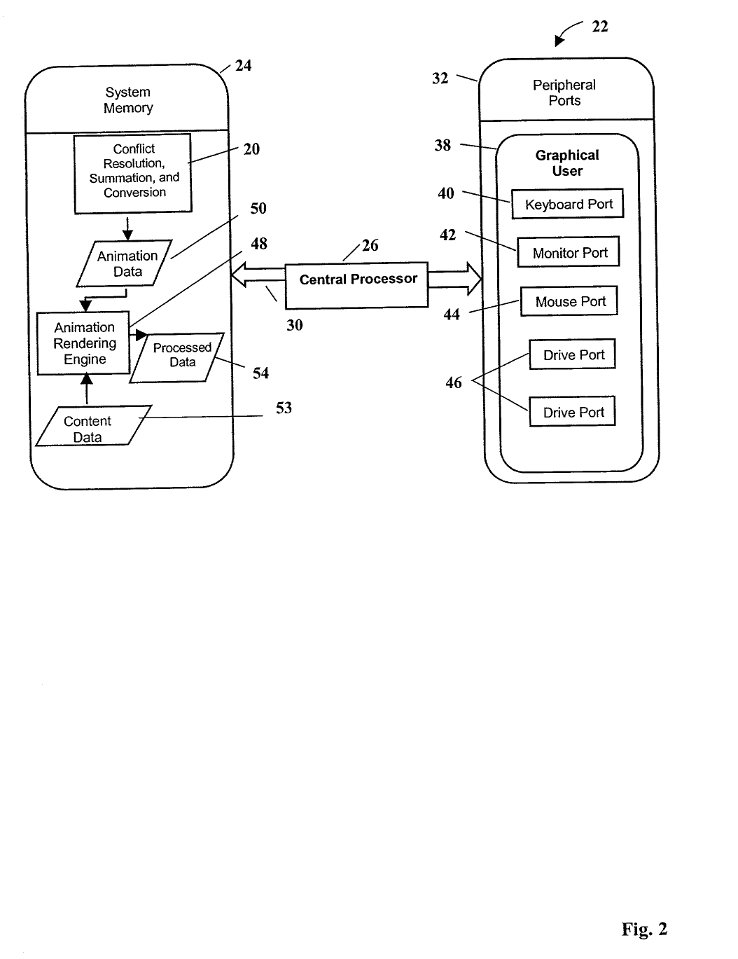

FIGS. 1 and 2 show the operating environment for the present invention. The present invention is a computer program that simulates the movements of a human speaker during speech. As those skilled in the art of computer programming recognize, computer programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art and the invention disclosed herein.

FIG. 1 is a block diagram showing a computer program for resolving conflicts, summing, and converting function curves, the Conflict Resolution, Summation, and Conversion Implementation 20, residing in a computer system 22. The Conflict Resolution, Summation, and Conversion Implementation 20 is stored within a system memory device 24. The computer system 22 also has a central processor 26 capable of executing an operating system 28. The operating system 28 also resides within the system memory device 24. The operating system 28 has a set of instructions that control the internal functions of the computer system 22. The operating system 28 controls internal functions in a conventional manner and well known to those of ordinary skill in the art. A system bus 30 communicates signals, such as data signals, control signals, and address signals, between the central processor 26, the system memory device 24, and at least one peripheral port 32. While the computer system 22 described, in a typical configuration, is a workstation available from Hewlett Packard, those of ordinary skill in the art understand that the program, processes, methods, and systems described in this patent are not limited to any particular computer system.

Those of ordinary skill in art also understand the central processor 26 is typically a microprocessor. Such microprocessors may include those available from Advanced Micro Devices under the name ATHLON™, and those available from The Intel Corporation under the general family of X86 and P86 microprocessors. While only one microprocessor is shown, those of ordinary skill in the art also recognize multiple processors may be utilized. Those of ordinary skill in the art well further understand that the program, processes, methods, and systems described in this patent are not limited to any particular manufacturer's central processor.

The system memory 24 also contains an application program 34 and a Basic Input/Output System (BIOS) program 36. The application program 34 cooperates with the operating system 28 and with the at least one peripheral port 32 to provide a Graphical User Interface (GUI) 38. The Graphical User Interface 38 is typically a combination of signals communicated along a keyboard port 40, a monitor port 42, a mouse port 44, and one or more drive ports 46. The Basic Input/Output System 36, as is well known in the art, interprets requests from the operating system 28. The Basic Input/Output System 36 then interfaces with the keyboard port 40, the monitor port 42, the mouse port 44, and the drive ports 46 to execute the request.

The operating system 28 may be one such as that available from the Microsoft Corporation under the name WINDOWS NT®. The WINDOWS NT® operating system is typically preinstalled in the system memory device 24 on the aforementioned Hewlett Packard workstation. Those of ordinary skill in the art also recognize many other operating systems are suitable, such as those available under the name UNIX® from the Open Source Group, the UNIX-based open source Linux operating system, and that available from Apple Computer, Inc. under the name Mac® OS. Those of ordinary skill in the art will again understand that the program, processes, methods, and systems described in this patent are not limited to any particular operating system.

FIG. 2 is also a block diagram showing the operating environment for the present invention. The Conflict Resolution, Summation, and Conversion Implementation 20 resides within the system memory 24. An animation-rendering engine 48 also resides within the system memory 24. The animation rendering engine 48 is a computer program that allows animators to turn 3-Dimensional views into a 2-Dimensional display image. The animation rendering engine 48 may add realistic lighting techniques to the 2-Dimensional display image, such as shading, simulated shadows, reflection, and refraction. The animation rendering engine 48 may also include the application of textures to the surfaces. The Conflict Resolution, Summation, and Conversion Implementation 20 produces animation data 50. As those of ordinary skill in the art of computer animation understand, the animation rendering engine 48 accepts the animation data 50 and combines the animation data 50 with content data 52. The animation rendering engine 48 processes the animation data 50 and the content data 52 and produces processed data 54. The processed data 54 is sent along the system bus 30 to the Graphical User Interface 38. The processed data 54 is then passed through the monitor port 42 and displayed on a monitor (not shown). The animation data 50 produced by the Conflict Resolution, Summation, and Conversion Implementation 20 results in the consistent performance of actions in an animation.

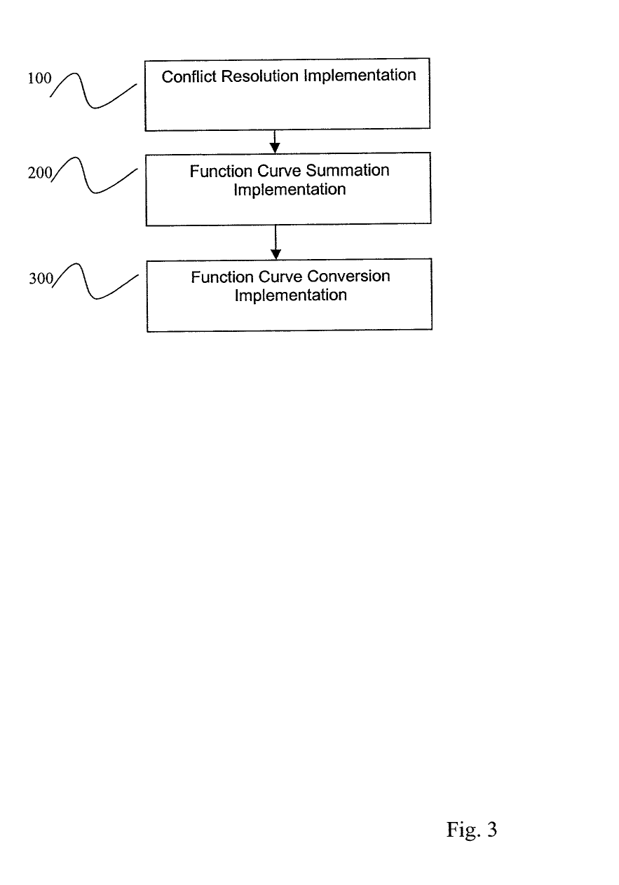

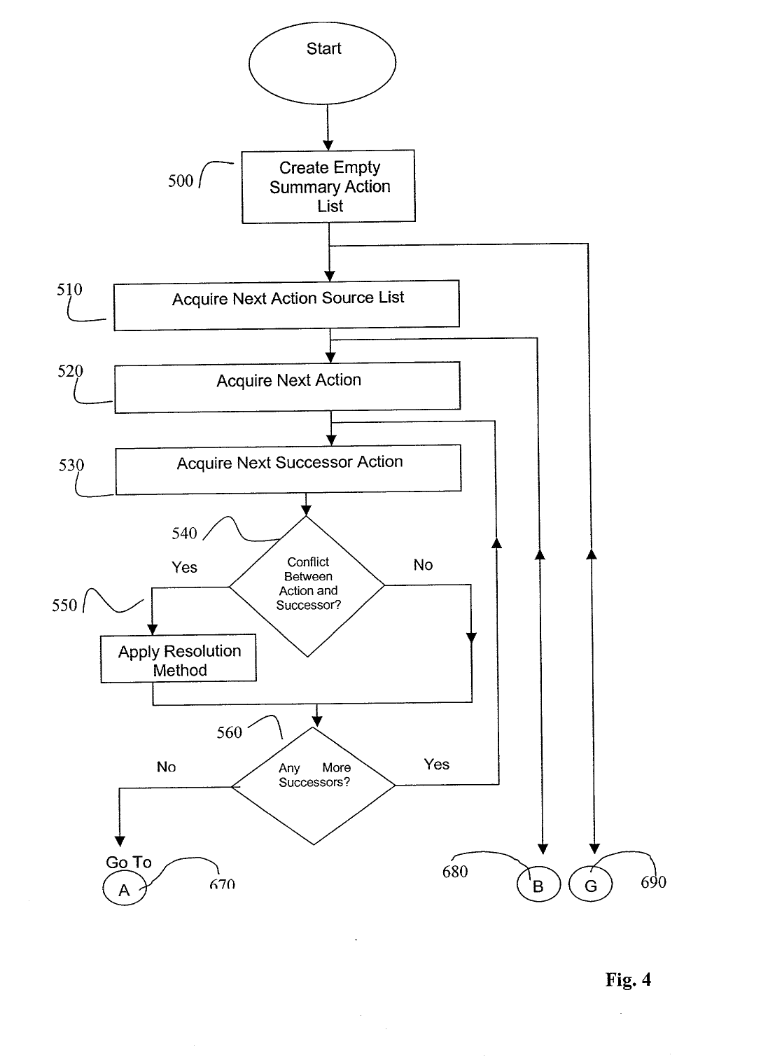

FIG. 3 is a flowchart describing the Conflict Resolution, Summation, and Conversion Implementation. The Conflict Resolution, Summation, and Conversion Implementation. At step 100, the Conflict Resolution Implementation resolves self-consistency conflicts in each source of action and resolves conflicts between two or more lists of actions. In step 200, the Summation Implementation creates a summation result curve by compiling a list of keys from the function curves and determining the values, derivatives in and derivatives out of the keys. In step 300, the Conversion Implementation converts a function curve from one mathematical representation to another. Each of the three aspects of the invention, Conflict Resolution, Summation, and Conversion Implementation, will be better understood by the following descriptions of FIGS. 4-10.

FIGS. 4, 5, and 6 are flowcharts describing the Conflict Resolution Implementation.

At Step 500 in FIG. 4 the Conflict Resolution Implementation creates an empty summary action list. In the context of the system and method disclosed herein, an action is a single time-constrained series of variations to an animatable quantity, along with the time of the action and any characteristics of the action necessary to unambiguously represent the action as a time slice of a function curve. The summary action list is the list, in order by time, of all such actions.

At step 510 the Conflict Resolution Implementation acquires the next single action source. A source may be either a set of inputs to the animation, or a rule or algorithm which generates actions. Such a rule or algorithm may or may not accept inputs based on data generated by the animation. An action source consists of or generates a time-ordered list of actions, referred to herein as the source action list. In our example, the blinks accompanying speech constitute the first source action list.

At step 520 the Conflict Resolution Implementation obtains the next action in the source action list. An example of such an action is a particular blink.

At step 530 the Conflict Resolution Implementation obtains the next action, i.e. the next successor action in the source action list, for example, the next blink. At step 540 the Conflict Resolution Implementation uses a conflict detection rule to determine conflicts between this action and its immediate successor in the action list. A conflict detection rule has the property that it considers only the characteristics and time of the actions it examines, and that it detects conflicts only between an action and that action's successors. For example, a conflict detection rule for blinks examines the time and duration of a blink, and determines if it overlaps in time with any of its successors.

If no conflict is detected, the algorithm skips step 550. Otherwise, a conflict resolution method is applied to the successor action in the source action list which is in conflict. A conflict resolution method has the property that it removes the state detected by the conflict detection rule through one or more of the following manipulations:

1) Removal of the successor action from the source action list. This conflict resolution method may be used for blinks. Thus, if a successor blink overlaps with a first blink, the successor blink is removed from the source action list.

2) Modification of the successor action's time. This conflict resolution method may also be used for blinks. For example, the successor blink's time could be increased so that it occurs late such that it no longer overlaps with the first blink.

3) Modification of the successor action's characteristics. This conflict resolution method may also be used for blinks. For example, the successor blink could be made shorter in addition to later so that it ends at the same time as before application of the resolution method.

4) Introduction of a new successor action. For example, if the action is to scratch one's nose, and the conflict detected is that the hand is holding a cup of coffee, the new successor action might be to put down the cup of coffee.

The algorithm now tests to see if there are any more successor actions in step 560, and loops back to step 530 until there are no more successors in the source action list.

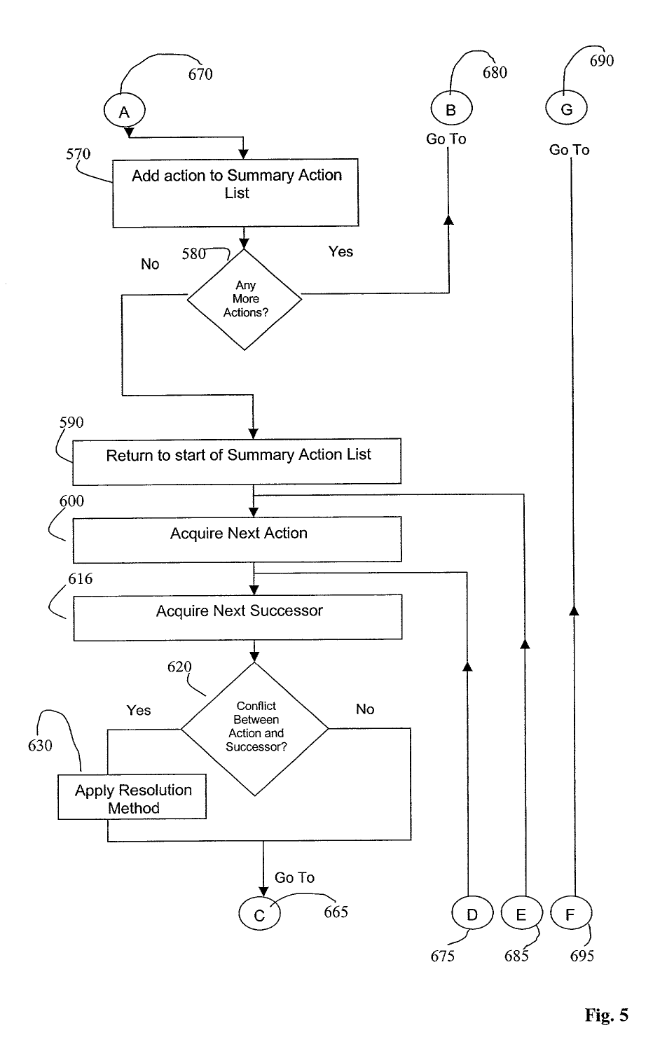

When there are no longer any successors in the source action list, the Conflict Resolution Implementation proceeds from point A 670 in FIG. 4 to point A 670 in FIG. 5. At step 570 in FIG. 5, the Conflict Resolution Implementation adds the conflict-free action to the summary action list.

If there are more actions in the source action list at step 580, the Conflict Resolution Implementation loops back to step 520 in FIG. 4 depicted through point B 680 in FIGS. 4 and 5. The Conflict Resolution Implementation continues the loop through point B 680 until the source action list is exhausted. Thus, if the action “put down cup of coffee” were tested by the Conflict Resolution Implementation with “scratch nose,” the conflict detection method would detect that the actions overlap. If the conflict resolution method designated for such a conflict is to shift the successor action in time, the sequence generated by the Conflict Resolution Implementation is as follows: put down coffee, and after it has been set down, scratch nose.

Therefore, after step 580 the action source list is self-consistent.

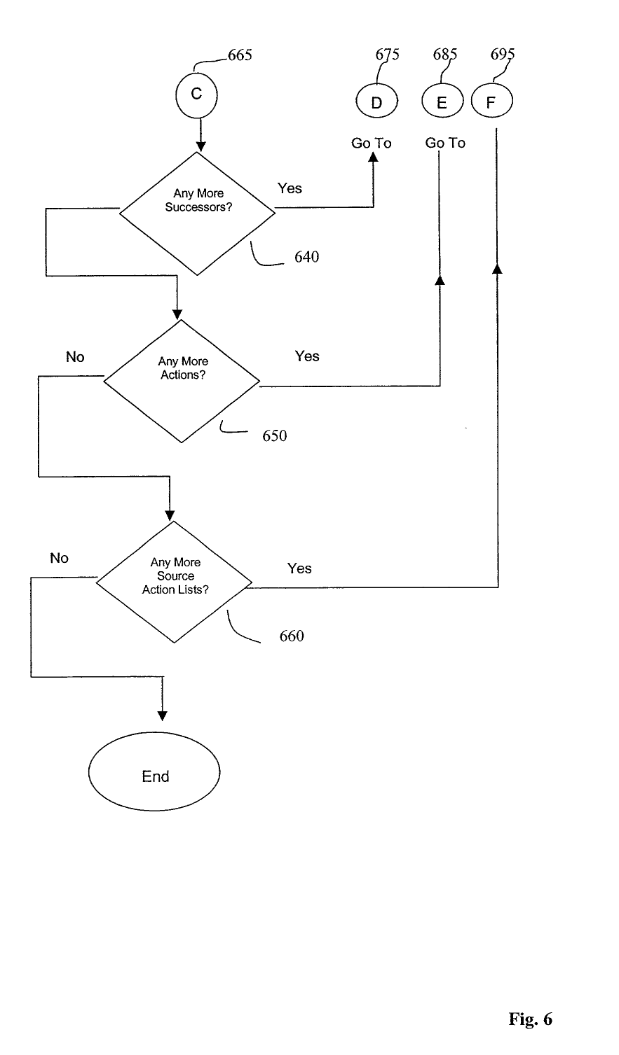

At step 590 the Conflict Resolution Implementation returns to the start of the summary action list, and at step 600 considers the next action in the list. The actions and their successors are tested and resolved in a manner similar to that described above for the source action list. In step 610, the next successor is considered, in 620 conflict is detected between action and successor, and the resolution method is applied in step 630 if a conflict has been detected. The flowchart depicted in FIG. 5 continues through point C 665 to FIG. 6.

If the Conflict Resolution Implementation detects more successors at step 640 in FIG. 6, the Conflict Resolution Implementation loops back to step 610 in FIG. 5, which is depicted through point D 675 in FIGS. 5 and 6 until all successors have been tested. Otherwise, if the Conflict Resolution Implementation detects more actions at step 650 in FIG. 6, the Conflict Resolution Implementation loops back to step 600, which is depicted through point E 685 in FIGS. 5 and 6. until the summary action list is exhausted. After step 650 in FIG. 6, the summary action list is conflict-free.

The Conflict Resolution Implementation now checks in step 660 to determine if all source action lists have been added to the summary action list. If not, the Conflict Resolution Implementation loops to step 510 in FIG. 4, depicted through points F and G in FIGS. 4, 5, and 6, and the next action source list is considered by the Conflict Resolution Implementation at step 510. The source action list may have been generated by examining the results of the summary action list to this point. The Conflict Resolution Implementation is able to maintain self-consistency and resolve conflicts in light of such dependencies. When all action source lists have been processed, the Conflict Resolution Implementation ends. The summary action list which results is the output of the Conflict Resolution Implementation.

The resulting summary action list may be converted into a conflict-free set of function curves because each action contains all the necessary information to convert to a set of function curves. As would be understood by one of ordinary skill in the art, the summary action list may be converted to a set of function curves using conventional conversion techniques.

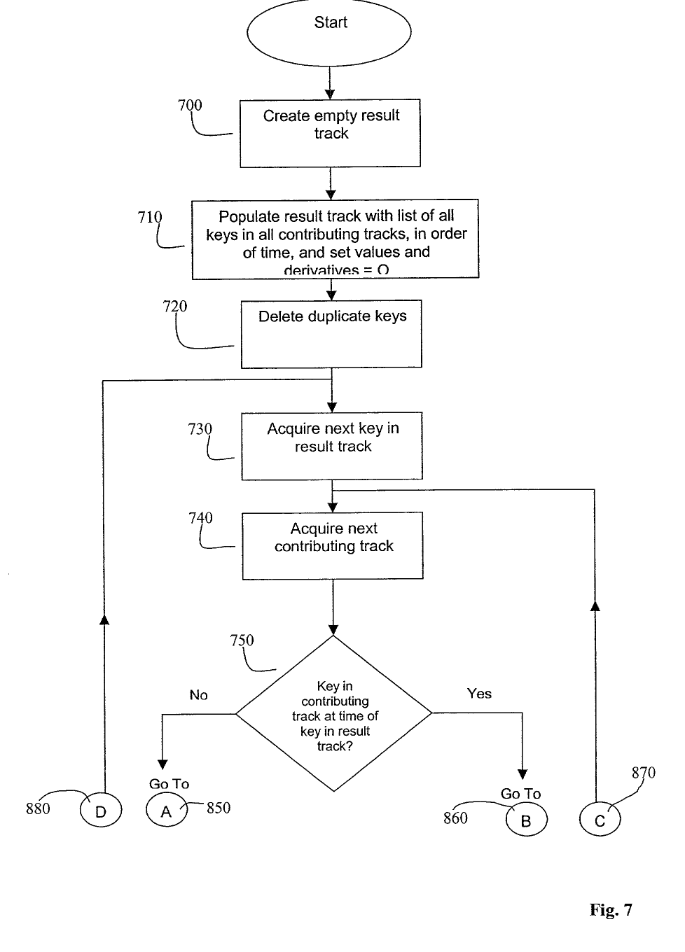

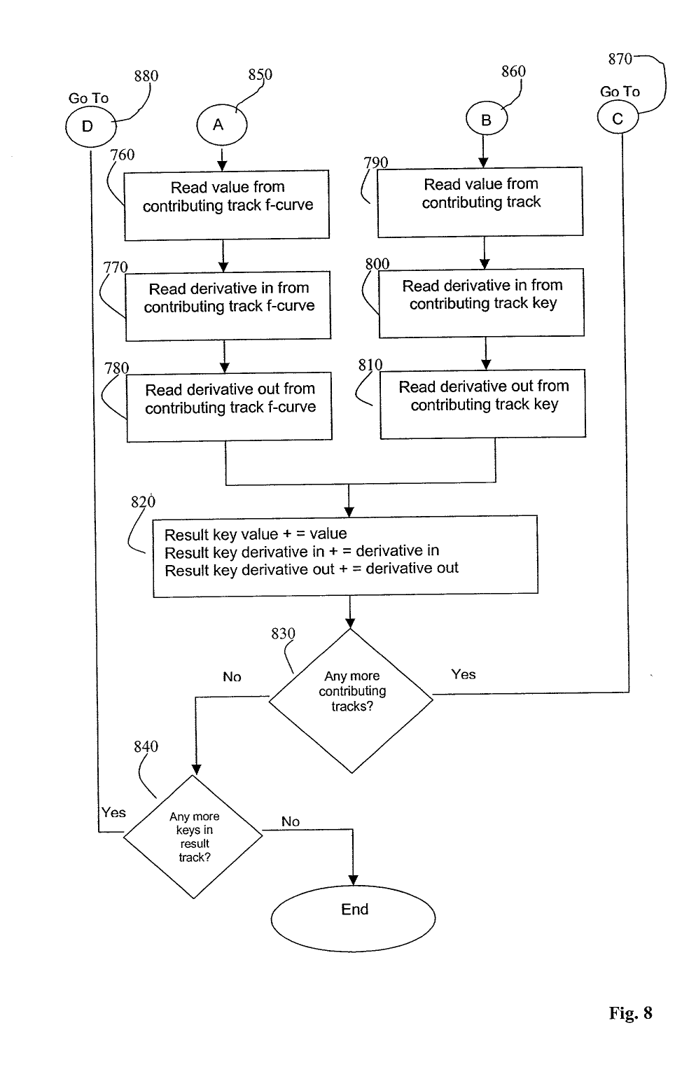

FIGS. 7 and 8 are flowcharts describing the Function Curve Summation Implementation.

The Function Curve Summation Implementation accepts as input a set of function curves, represented as tracks. A track is a list of keys each of which has a time, a value, a derivative in, and a derivative out. The derivatives need not be equal. These tracks are herein referred to as contributing tracks.

At Step 700 in FIG. 7 the Function Curve Summation Implementation creates an empty result track for the result.

At step 710, the Function Curve Summation Implementation populates the result track with the keys in all the contributing tracks. The keys in the result track are ordered in time, with their values and derivatives arbitrarily initialized to 0.

At step 720, the Function Curve Summation Implementation deletes duplicate keys in the result track. That is, if more than one key shares the same time, all but one key is deleted. There is now a single key in the result track anywhere that there is a key in at least one of the contributing tracks. Preferably, in a more efficient embodiment, duplicate keys are detected before they are added to the list, so that the list need not be traversed again to detect them.

At step 730, the Function Curve Summation Implementation acquires the next key in the result track.

At step 740, the Function Curve Summation Implementation acquires the next contributing track.

At step 750, the Function Curve Summation Implementation determines if there is a key in the contributing track at the same time as the key under consideration in the result track. If yes, the flowchart is depicted through point B 860 from FIG. 7 to point B 860 in FIG. 8. Then, at steps 790, 800, and 810 in FIG. 8, the Function Curve Summation Implementation reads the value, derivative in, and derivative out directly from the key. If no, the flowchart is depicted through point A 850 from FIG. 7 to point A 850 in FIG. 8. At steps 760, 770, and 780 in FIG. 8, the Function Curve Summation Implementation reads the value from the curve and approximates the derivatives using a numerical method. After the derivatives have been determined, at step 1030, the Function Curve Summation Implementation increments the values and derivatives in the result track with the derivative values.

If the Function Curve Summation Implementation determines that there are more contributing tracks at step 830, the Function Curve Summation Implementation loops back to step 740 in FIG. 7, which as depicted in FIGS. 7 and 8 through point C 870, to add the contributions to the current result key. If not, and the Function Curve Summation Implementation determines that there are more result keys to consider at step 840, the Function Curve Summation Implementation loops back to step 730 to find the value and derivatives for the next key. When the value and derivatives of all keys in the result track have been found, the Function Curve Summation Implementation ends. The result track constitutes the output of the Function Curve Summation Implementation.

If the mathematical representation is such that the time values and the derivatives in and out uniquely define the curve through these keys, the result curve will be at every point equal to the sum of the values of the contributing curves.

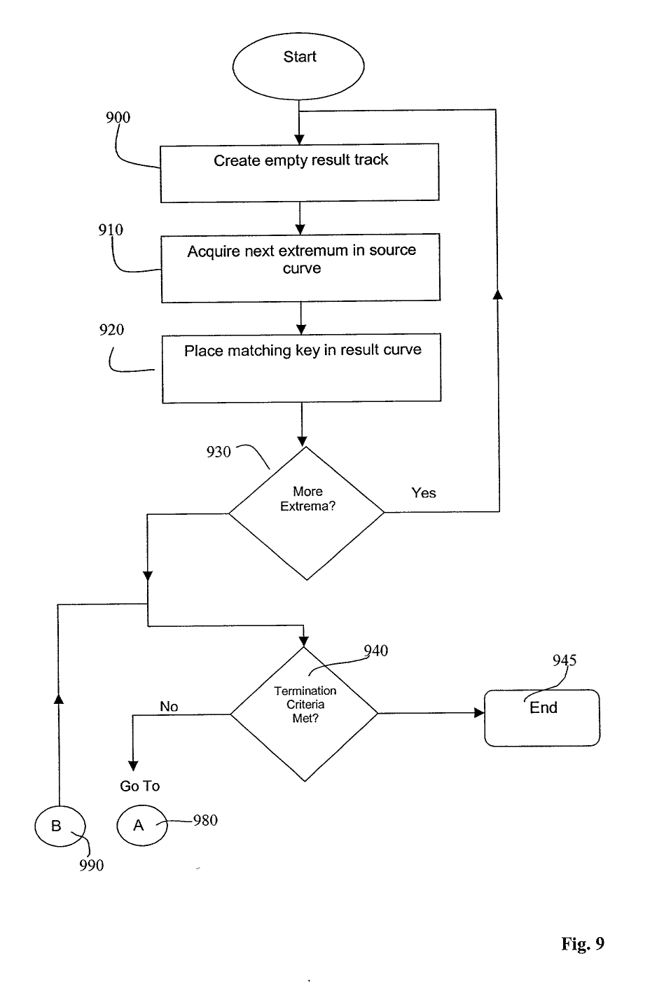

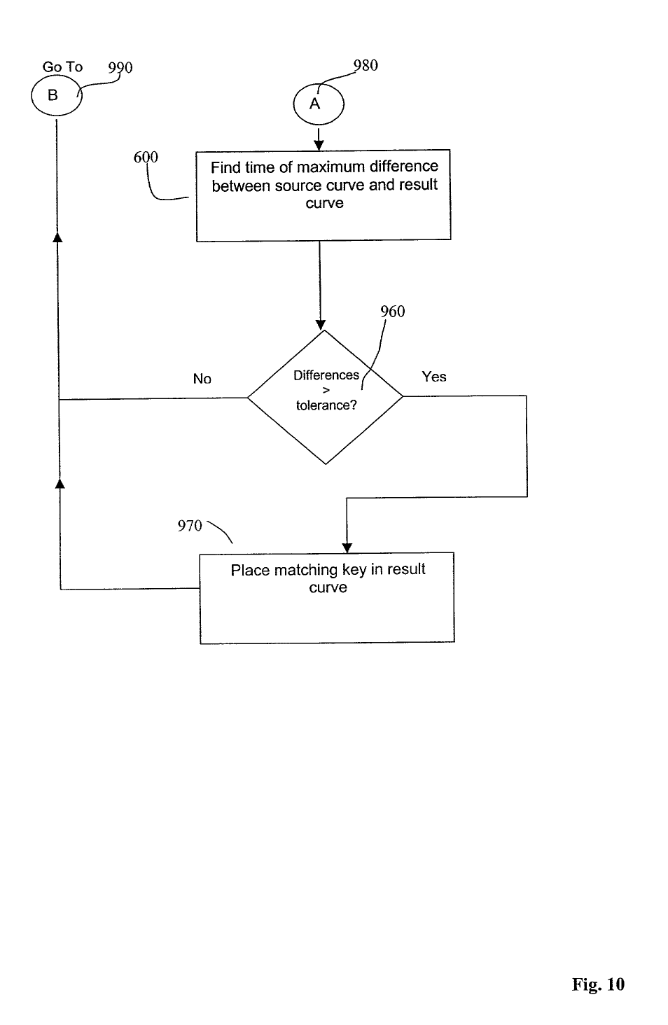

FIGS. 9 and 10 are flowcharts describing the Conversion of Function Curve Implementation.

At Step 900 in FIG. 9 a result track is created for the output of the Conversion of Function Curve Implementation.

At Step 910 the Conversion of Function Curve Implementation acquires the next extremum in the source curve. As would be readily understood by those of ordinary skill in the art, if the mathematical representation of the source curve is known, the extrema may be found by analytical means, otherwise a standard numerical method for extraction of extrema may be used.

At step 920, the Conversion of Function Curve Implementation places a key in the result track with the same value, time, derivative in and derivative out as the source curve. The derivate in and out of the source curve at extrema will be 0 if the curve is continuous. However, continuity is not necessary. As would be readily understood by those of ordinary skill in the art, if the mathematical representation of the source curve is not known, it is necessary to use a numerical method to determine the derivatives in and out. If derivatives cannot be explicitly specified in the new curve representation, the derivatives are discarded throughout the implementation. If the Conversion of Function Curve Implementation detects that there are more extrema at step 930, the Conversion of Function Curve Implementation loops back to step 910 until all extrema have been processed.

The method and system described by steps 900, 910, 920, and 930, give an approximation across a wide variety of representations by minimizing the risk of “overshoots” and “undershoots”, a condition where unintended maxima and minima occur between keys. This is accomplished by the choice of extrema in the source curve as locations for the placement of matching keys in the result curve, as a first approximation.

At Step 940 the Conversion of Function Curve Implementation applies the termination criteria test, to see if mere placement of keys at the extrema was sufficient to create a matching curve. It is desirable for the Conversion of Function Curve Implementation to terminate if the difference between the curves yields a value below some threshold. The Conversion of Function Curve Implementation also terminates if a key count, iteration count (or the computational time elapsed) exceeds some threshold. As would be understood by one of ordinary skill in the art, the difference between the curves can be calculated as the integral difference, the maximum value difference, or some similar quantity. This value is referred to herein as the “error function.” If both mathematical representations are known, this quantity can be found analytically, otherwise a standard numerical method may be used.

As would be understood by one of ordinary skill in the art, it is possible that the mathematical representation of both curves may be unspecified and may be such that the function curve will be ill-behaved. By ill-behaved is meant that the curve interpolations between keys is not predictable such that there is the possibility that placement of a key in the new curve will cause an increase in the difference between the curves. Thus, it is possible that the error function could diverge. Therefore, if the addition of a key in the result curve causes a divergence in the error key, the Conversion of Function Curve Implementation removes the key before termination.

In addition, the termination criterion regarding the difference in error function might require a large number of iterations. For this reason, the second part of the termination requirement measures elapsed time or number of iteration loops. The Conversion of Function Curve Implementation ends if a threshold elapsed time or number of iterations is exceeded.

If the termination criterion is met, the Conversion of Function Curve Implementation ends at step 945 and reports the error function value, and the number of keys, iterations or time elapsed. The result track is the output of the Conversion of Function Curve Implementation.

If the termination criterion is not met, the flowchart in FIG. 9 continues to FIG. 10, which is depicted through point A 980 in FIGS. 9 and 10. At step 950 in FIG. 10, the Conversion of Function Curve Implementation determines the time or point where the difference between the values of the source curve and the result curve is at a maximum. If both mathematical representations are known, this may be determined analytically. Otherwise, as would be understood by one of ordinary skill in the art, a standard numerical method may be used. For example, the two function curves may be subtracted at small intervals to find the largest difference. The Conversion of Function Curve Implementation compares the difference between the curves at the point of maximum difference to a tolerance. If the difference is more than the tolerance, the Conversion of Function Curve Implementation places a new key at step 970. Thus, at step 970, a new key is placed in the new track at the time of maximum difference. The time, values, derivative in, and derivative out are determined by the Conversion of Function Curve Implementation by reading the source curve at the point of maximum difference. As would be understood by one of ordinary skill in the art, if the mathematical representation of the source curve is unknown, it may be necessary to use a numerical method to determine the derivatives in and out. If derivatives cannot be explicitly specified in the new curve representation, the derivatives are discarded. The Conversion of Function Curve Implementation then loops to step 940 in FIG. 9, which is depicted through point B 990 in FIGS. 9 and 10, to check for termination criteria satisfaction.

What is claimed is:

1. A method of detecting and resolving conflicts which arise between actions contributing to animation of a quantity, comprising:
A. resolving self-consistency conflicts in each source of the action; and
B. resolving conflicts between two or more lists of actions.

2. The method of claim 1, wherein said resolving self-consistency conflicts further comprises:
A. compiling a list of actions from a source;
B. testing for a conflict condition between an action and successor actions in the action list; and
C. applying a resolution method to conflicts detected.

3. The method of claim 1, wherein said applying a resolution method further comprises: at least one of the steps of
A. introducing at least one successor action to said source action list;
B. removing at least one successor action to said source action list; and
C. modification of at least one successor action in said source action list.

4. The method of claim 1, wherein said resolving conflicts between two or more lists of actions further comprises:
A. for each action in lists of actions, adding the action to a cumulative action summary list;
B. after inserting an action into said cumulative action summary list, testing for a conflict condition between the action and its successors in the action summary list; and
C. applying a resolution method to conflicts detected, wherein said applying a resolution method further comprises at least one of the steps of:
1. introducing at least one successor action to said source action list;
2. removing at least one successor action to said source action list; and
3. modification of at least one successor action in said source action list.

5. A method of creating a result curve from a set of function curves, comprising:
A. compiling a time-ordered list of keys from said function curves; and
B. determining the values and derivatives in and derivatives out of said keys, wherein said time values, derivatives in, and derivatives out uniquely define the result curve through said list of keys.

6. The method of claim 5, wherein said compiling list of keys further comprises:
if multiple keys have the same time associated therewith, deleting all but one multiplicative key.

7. The method of claim 5, further comprising: for each key in said list of keys, setting the value of the key to the sum of the function curves at the time of the key.

8. The method of claim 5, further comprising: for each key in said list of keys,
A. setting the derivative in of the key to the sum of the derivatives in of the function curves at the time of the key, and
B. setting the derivative out of the key to the sum of the derivatives out of the function curves at the time of the key.

9. A method of converting a first function curve from a first mathematical representation to a second mathematical representation, comprising:
A. reading keys from a first curve, wherein said first curve is defined in terms of a first mathematical representation and has times, values, and derivatives associated therewith; and
B. placing keys in a second curve corresponding to the extrema of said first curve, wherein said second curve is represented by a second mathematical representation, and the times, values, and derivatives associated with the keys in said second curve are equal to the corresponding values in said first curve.

10. The method of claim 9, further comprising:
A. determining points of maximum discrepancy between said first and said second curve; and
B. placing new keys iteratively in said second curve at the points of maximum discrepancy between the first and second curves, wherein the value in the new keys are obtained from said first curve; and
C. terminating said placing new keys if termination criteria is met.

11. The method of claim 10, wherein the derivative in and derivative out of the new keys is obtained from said first curve.

12. The method of claim 10, wherein said termination criteria is met if the measure of the difference between said first and second curves are less than a threshold value, if a threshold number of placing new key iterations has occurred, or if a threshold amount of run time has elapsed.

13. A system for detecting and resolving conflicts which arise between actions contributing to animation of a quantity, comprising:
A. a computer system;
B. a program stored on said computer system for detecting and resolving conflicts which arise between actions contributing to animation of a quantity;
C. said program being further configured to resolve self-consistency conflicts in each source of the action;
D. said program being further configured to resolve conflicts between two or more lists of actions.

14. The system of claim 13, wherein said program is further configured to create a result curve from a set of function curves, wherein said program compiles a time-ordered list of keys from said function curves and determines a value and derivative in and derivative out for each of said keys.

15. The system of claim 13, wherein:
A. said program is further configured to convert a function curve from a first mathematical representation to a second mathematical representation by reading keys from a first curve defined in terms of the first mathematical representation and having keys comprising times, values, a derivative in and a derivative out associated therewith; and
B. said program is further configured to place keys in a second curve defined in terms of a second mathematical representation corresponding to the extrema of said first curve, wherein said second curve has keys comprising times, values, a derivative in and a derivative out associated therewith.

16. The system of claim 13, wherein said program is further configured to compile a list of actions from a source of actions, test for a conflict between each action and successor action in the action list, and apply a resolution method to conflicts detected.

17. The system of claim 14, wherein said program is further configured to delete all but one multiplicative keys from the list of keys.

18. The system of claim 15, wherein said program is further configured to determine points of maximum discrepancy between said first and second curve, place new keys iteratively in said second curve at the points of maximum discrepancy, wherein the value, derivative in and derivative out of the new keys are obtained from said first curve, and terminating the placement of new keys if termination criteria is met.

19. The system of claim 16, wherein said program is further configured to add an action to a cumulative action summary list and test for conflict conditions between the action and its successors in the action summary list, and apply a resolution method to conflicts detected.

20. The system of claim 17, wherein said program is further configured to set the value of each key to the sum of the function curves at the time of the key, set the value of the derivative in of the key to the sum of the derivatives in of the function curves at the time of the key, and set the derivative out of the key to the sum of the derivatives out of the function curves at the time of the key.

21. The method of claim 18, wherein said termination criteria is met if the measure of difference between said first and second curves is less than a threshold value, if a threshold number of new keys have been placed, or if a threshold amount of run time has elapsed.
